(19) United States
(12) Patent Application Publication
(10) Pub. No.: US 2006/0005690 A1
(43) Pub. Date: Jan. 12, 2006

(54) Sound synthesiser

(76) Inventors: Thomas Jacobsson, Genarp (SE); Andrej Petef, Malmo (SE); Alberto Jimenez Felstrom, Fuengirola-Malaga (ES)

Correspondence Address: Steven M duBois;Potomac Patent Group, PO Box 270, Fredericksburg, VA, 22404, US

(21) Appl. No.: 10/526,522

(22) PCT Filed: Aug. 11, 2003
(86) PCT No.: PCT/EP03/08902

§ 371 Date: Jul. 11, 2005

Related U.S. Application Data
(60) Provisional application No. 60/409,744, filed on Sep. 10, 2002.

(30) Foreign Application Priority Data
Sep. 2, 2002 (EP) 02256081.7

(51) Int. Cl. G10H 7/00

(52) U.S. Cl. 84/603

(57) ABSTRACT

A sound synthesizer is provided that reduces the computational requirements of a synthesizer with a high degree of polyphony, while ensuring that audible artifacts are kept to a minimum. The synthesizer comprises a plurality of samples stored in a memory; a plurality of voices each comprising means for calculating an output using a plurality of samples selected from the plurality of samples stored in the memory; wherein a voice is active when calculating an output; wherein the number of samples selected by the means for calculating depends upon the number of active voices.

### TECHNICAL FIELD OF THE INVENTION

This invention relates to sound synthesisers, and more specifically to sound synthesisers used in devices where the computational resources are limited, such as in portable devices.

### BACKGROUND OF THE INVENTION

Modern sound synthesisers are required to have a large number of voices. The number of voices a synthesiser has is defined as the number of sounds that can be generated simultaneously.

There are several different protocols and standards that define how electronic sound synthesisers reproduce a required set of sounds.

One popular way of generating sounds in electronic devices is by using the MIDI (Musical Instrument Digital Interface) protocol. Unlike digital audio files, (such as those found on compact disks) a MIDI file does not contain details of specific sounds. Instead, the MIDI file contains a list of events that a device must perform in order to recreate the correct sound. Sampled sounds are stored in the synthesiser and are accessed according to the instructions contained in the MIDI file. Therefore, MIDI files can be much smaller than digital audio files and are suited to an environment where storage memory is limited.

In the General MIDI System Level 1 (GM-1), a synthesiser is required to have at least 24 voices.

Synthesisers, such as MIDI synthesisers, that generate sounds from pre-recorded sounds are known as wave-table based synthesisers. In such a synthesiser, one or several pre-recorded sequences of a musical instrument will be stored in a wave-table. Each sequence will contain a series of samples that are played in order to recreate the sound.

Often, a musical instrument can generate a high number of notes, and since sampling and recording every possible note would require a lot of memory, only a few notes are stored.

Therefore, when a synthesiser is required to produce a note or sound that has a frequency that is different to one stored in the memory, the synthesiser uses one of the stored sequences and a technique known as ‘sample rate conversion’ to re-sample it and change the frequency and obtain the requested tone.

Changing the frequency of the stored sequence is achieved by accessing the stored samples at different rates. That is to say, for example, if the stored samples represent a musical note at a frequency of 300 Hz, accessing every sample in turn will reproduce the musical note at 300 Hz. If each stored sample is output twice before the next stored sample is read out, the note reproduced by the synthesiser will have a frequency of 150 Hz. Similarly, if a note of 600 Hz is required then every other stored sample is read out.

It is important to note that the rate at which samples are output by the synthesiser remains constant and is equal to one sample period (the time between each stored sample).

In the example above, by accessing every sample twice, artefacts (distortions) will be introduced into the output sound. To overcome these distortions, the synthesiser computes additional samples based on the stored samples. Therefore, in the 150 Hz example above, instead of repeating each stored sample twice, the synthesiser will output one stored sample and calculate the next sample on the basis of the surrounding stored samples.

To do this, the synthesiser requires an interpolation technique.

The simplest interpolation technique uses a weighted average of the two surrounding samples. However, this technique is often inaccurate and still results in audible distortions.

The optimum interpolation algorithm uses a sin(x)/x function and requires an infinite number of calculations. Of course, this is impractical and therefore sub-optimum algorithms have been developed.

One sub-optimum interpolation technique is described in Chapter 8 of “Applications of DSP to Audio and Acoustics” by Dana C. Massie, where several stored samples are used in the calculation (the number of samples used in the interpolation is known as the interpolation degree). The larger the number of samples used in the interpolation, the better the performance of the synthesiser.

In a synthesiser, each voice is implemented using one or several digital signal processors (DSPs) and the computational power of the DSP system imposes a limit on the number of voices that a synthesiser can produce, and also limits the interpolation degree used for each voice.

When using a sub-optimum interpolation algorithm such as a truncated sin(x)/x algorithm, the computational complexity grows linearly with the interpolation degree.

In many commercial synthesisers, an interpolation degree of 10 is often used as this results in a good trade-off between computational complexity and sound quality.

### SUMMARY OF THE INVENTION

It is desirable to be able to implement MIDI sound synthesisers in portable devices, such as mobile phones, to allow the devices to produce polyphonic ring tones and higher quality sounds.

However, the limits placed on computational power in a portable device (such as by cost and available space in the device) are not sufficient to allow the implementation of a sound synthesiser that conforms to the General MIDI System Level 1 (GM-1) (i.e. having 24 voices) and has an interpolation degree of around 10.

The present invention therefore seeks to provide a sound synthesiser that reduces the computational requirements of a synthesiser with a high degree of polyphony, while keeping audible artefacts to a minimum.

Therefore, according to a first aspect of the present invention there is provided a synthesiser that comprises a memory, containing a plurality of stored samples; means for calculating an output signal for each of a plurality of active voices, using a plurality of samples selected from the stored samples for each of the active voices; wherein the number of samples used for each active voice by the means for calculating depends upon the number of active voices.

Preferably, each voice is only able to compute one output at a time.

Preferably, the number of samples used for each active voice by the means for calculating decreases as the number of active voices increases.

Preferably, the number of samples used for each active voice by the means for calculating decreases as the number of active voices increases so that a maximum computational complexity is not exceeded.

Alternatively, the number of samples used for each active voice by the means for calculating decreases non-linearly as the number of active voices increases.

Preferably, the plurality of samples stored in the memory comprise samples of musical notes.

Preferably, the plurality of samples stored in the memory comprise samples of musical notes produced by different musical instruments.

According to a second aspect of the present invention, there is provided a portable device that comprises a music synthesiser as described above.

Preferably, the portable device is a mobile telephone.

Alternatively, the portable device is a pager.

It should be noted that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

For a better understanding of the present invention and to show how it may be carried into effect, reference will now be made by way of example to the accompanying drawings, in which:

FIG. 1 shows a sound synthesiser in accordance with the invention.

FIG. 2 shows a method performed by the controller of FIG. 1 in accordance with the invention.

FIG. 3 shows a scheme for determining the interpolation degree based on the number of active voices in accordance with the invention.

FIG. 4 shows an alternative scheme for determining the interpolation degree based on the number of active voices in accordance with the invention.

FIG. 5 shows a voice of the synthesiser of FIG. 1 in more detail.

FIG. 6 shows a mobile phone with a music synthesiser in accordance with the invention.

### DETAILED DESCRIPTION OF THE PREFERRED EMBODIMENTS

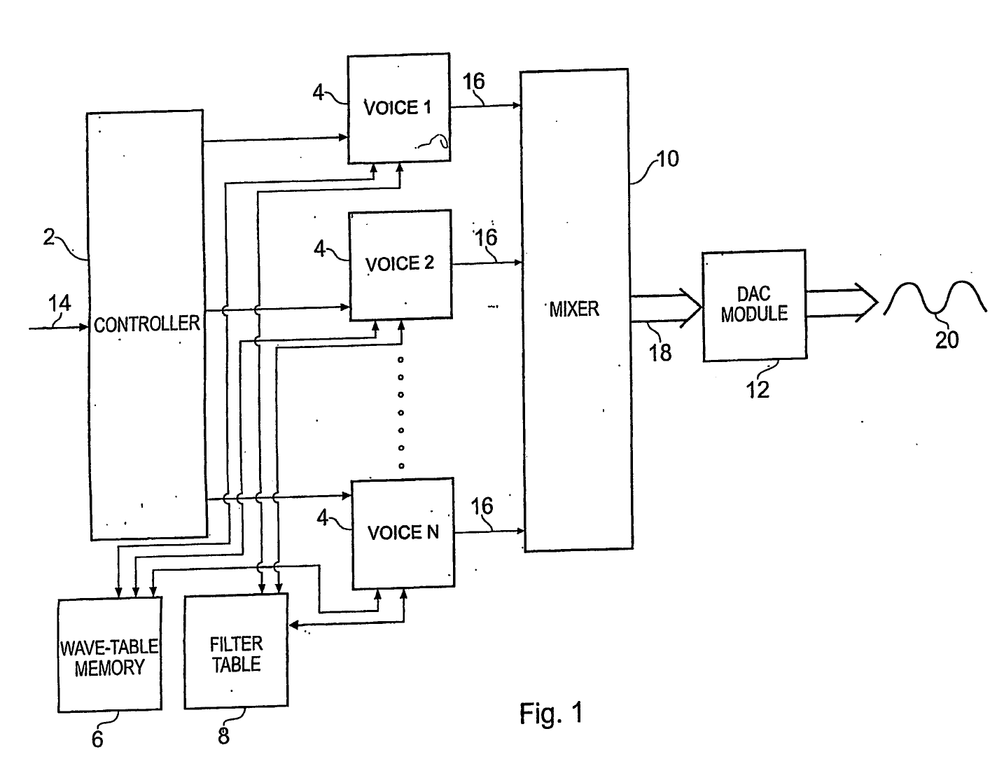

FIG. 1 shows a music synthesiser in accordance with the invention. As is conventional, the synthesiser comprises a controller 2, a plurality of voices 4, a wave-table memory 6, a filter table 8, a mixer 10 and a digital-to-analogue conversion module 12.

Although the synthesiser is hereinafter described as a wave-table based synthesiser that uses the MIDI protocol, it will be appreciated that the invention is applicable to any wave-table based synthesiser that is required to calculate a sample that lies between two stored samples.

It should be noted that the term ‘sample’ used herein, refers to a single audio sample point.

The total number N of voices 4 in the synthesiser defines the maximum polyphony of the system. As N increases, the polyphony increases allowing a greater number of sounds to be produced simultaneously. For a MIDI synthesiser conforming to the General MIDI System Level 1 (GM-1), the value of N will be at least 24. For clarity, only three voices are shown in FIG. 1.

The controller 2 receives data through an input 14. The data will comprise a stream of MIDI information that relates to a piece of music or specific set of sounds. Each MIDI file will contain a list of events that describe the specific steps that the synthesiser must perform in order to generate the required sounds.

In the case of MIDI files stored within portable communication devices, a file may, for example, relate to a short piece of music that can be used as a ring-tone.

The controller 2 processes the MIDI data stream and directs the appropriate parts of the data to the relevant voices 4 so that the required sound can be synthesised. For example, the required sound may consist of several different instruments playing at once, and therefore each voice 4 will handle one monophonic instrument or one part of a polyphonic instrument at a time. Often, the MIDI file will contain instructions relating to the particular voices 4 that are to be used in synthesising the next output.

Depending upon the particular content of the MIDI file, a different number of voices may be in use at any one time, depending upon the particular piece of music being reproduced.

Each voice 4 is connected to the controller 2, the mixer 10, the wave-table memory 6 and the filter table 8.

The wave-table memory 6 contains a number of sequences of digital samples. Each sequence may, for example, represent a musical note for a particular musical instrument. Due to restrictions on memory, only a few notes per instrument may be stored.

Filter table 8 contains a number of values of a filter. In a preferred embodiment, the values represent a sinc function (where a sinc function is (sin(x))/x).

Although not shown in FIG. 1, both the wave-table memory 6 and the filter table 8 have a multiplexer that allows each table to be accessed more than once per sample period (a sample period is defined as the inverse of the sampling rate, i.e. the rate at which the original sound was sampled). Therefore, each of voices 1 to N can share the same set of resources.

As is conventional, a voice 4, based upon the instructions received from the controller 2 and the interpolation degree of the system, produces the required output sample 16.

Often the sound to be produced by a particular voice 4 does not correspond in frequency to one of the stored sequences of samples. Therefore, the voice 4 must ‘shift’ the frequency of the stored sequence to produce a sound at the required frequency.

For example, if a stored sequence of samples represents a middle C note on a piano, then this sequence can be shifted in frequency to obtain a C# note or D note.

The frequency of the required sound can be expressed as a multiple of the frequency of the stored sequence. This multiple is written as a rational number M/L and is known as the phase increment.

Therefore, if the required frequency is twice the frequency of the stored sequence, then the phase increment will be equal to 2. If the required frequency is half the frequency of the stored sequence then the phase increment will be equal to ½. In the example where a C# note is required, the phase increment will be the twelfth root of 2 (an irrational number) which can be approximated by a rational number.

Often, when the frequency of a stored sequence of samples is shifted, the required samples are not stored in the memory. That is, the required sample falls between two stored samples.

Therefore, the voice 4 retrieves a number of samples surrounding the required sample from the wave-table memory 6 and an equal number of filter coefficients from the filter table 8. Each sample retrieved from the wave-table memory 6 is then multiplied with an appropriate filter coefficient from the filter table 8 and the products combined to produce the output of the voice 16.

The coefficients of the filter table 8 are chosen so that, if the wave-table memory 6 does contain the required sample, then the other samples retrieved from the wave-table memory 6 are multiplied by a zero filter coefficient and the stored sample is output.

In a preferred embodiment where the filter table 8 contains values that are representative of a sinc function, the period of the sinc function is twice the sample period.

Each output 16 of a voice 4 is sent to a mixer 10 where the outputs 16 of all active voices 4 are combined into a combined output 18 and passed to the DAC module 12.

The DAC module 12 contains one or more digital-to-analogue converters that convert the combined output 18 of the mixer 10 to an analogue signal 20.

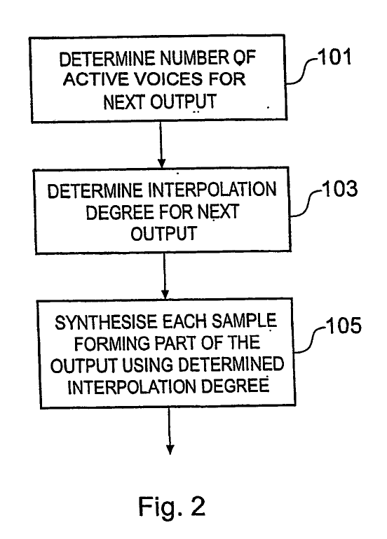

FIG. 2 shows a method performed by the controller 2 of FIG. 1 in accordance with the invention.

In step 101, the controller 2 analyses the MIDI data stream and determines the number of voices 4 that will be active during the next sample period. That is, the controller 2 determines how many different voices 4 will be contributing outputs 16 to the mixer 10.

In step 103, the controller 2 determines the number of samples to be used by each voice 4 in calculating the next output 16 (known as the interpolation degree I_{D}) and instructs the voices 4 appropriately.

In step 105, each active voice 4 calculates an output 16 on the basis of instructions received from the controller 2 using a number of stored samples in the calculation equal to the interpolation degree I_{D}. Each active voice 4 will also use a number of filter coefficients from the filter coefficient table 8 equal to the interpolation degree I_{D}.

The process repeats for each output cycle, i.e. the process is repeated once every sample period.

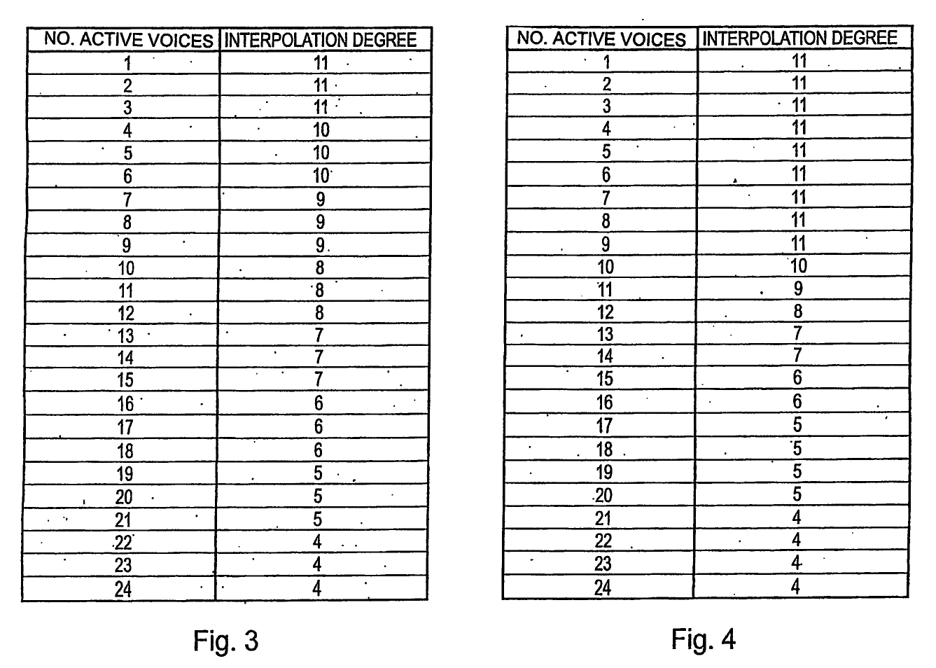

In the embodiments of the invention described with reference to FIGS. 3 and 4, the synthesiser has 24 voices 4 and has a maximum interpolation degree of 11.

FIG. 3 is a table that shows a scheme for determining the interpolation degree based on the number of active voices in accordance with the invention. Specifically, for any given number of active voices, the table gives the interpolation degree to be used.

For example, if the controller 2 determines that only one voice 4 will be active during the next sample period, the controller 2 instructs the voice 4 to use an interpolation degree of 11.

As the number of active voices 4 increases, the interpolation degree used in the calculation of the outputs 16 decreases in a linear fashion.

If all 24 voices 4 of the synthesiser are active then the controller 2 determines that an interpolation degree of 4 will be used.

Alternatively, if a maximum computational complexity is defined for the synthesiser, such as for a synthesiser used in a portable device, the interpolation degree may be chosen such that the maximum computational complexity is not exceeded.

FIG. 4 is another table that shows such a scheme. Again, the interpolation degree decreases as the number of active voices 4 increases. However, the change is not linear. Instead, the interpolation degree is calculated so that the maximum computational complexity is not exceeded.

For example, if a synthesiser has 24 voices, a maximum interpolation degree of 11 and consumes 0.5 MIPS/degree/voice (Millions of Instructions Per Second/degree/voice) then a conventional synthesiser may require up to 132 MIPS. This computational power far exceeds that available in a typical current portable device such as a mobile terminal.

Using the scheme shown in FIG. 4, the computational power will not exceed 50 MIPS. This value is more appropriate for a portable device.

The actual scheme used will be determined by the computational power available to the synthesiser and the amount of computational power required to implement each degree of interpolation.

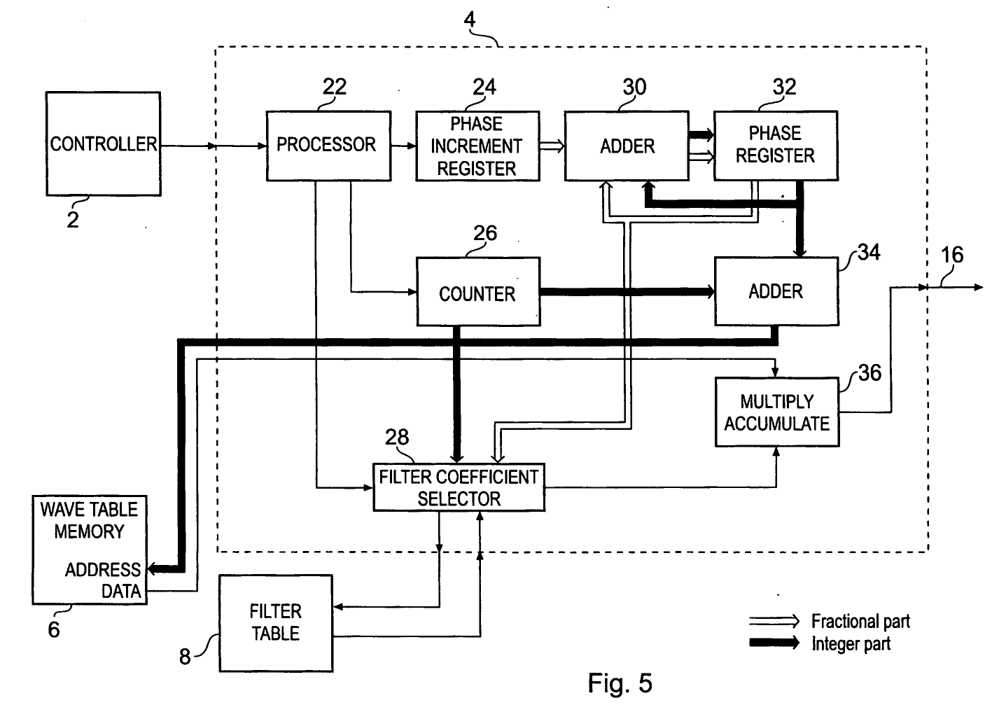

FIG. 5 shows a voice of FIG. 1 in more detail. The voice 4 is shown with the controller 2, wave-table memory 6 and filter table 8.

A processor 22 receives the instructions relevant to the voice 4 from the controller 2. The instructions will comprise the MIDI information relevant to the voice 4 and an indication relating to the interpolation degree to be used in calculating the next output 16.

The controller 2 may indicate to each voice 4 the actual interpolation degree that is to be used in calculating the next output, or alternatively, the controller 2 may indicate the number of active voices to each voice 4 and let the processor 22 determine the appropriate interpolation degree.

The processor 22 is connected to a phase increment register 24, a counter 26 and a filter coefficient selector 28.

The filter coefficient selector 28 is connected to the filter table 8 for retrieving appropriate filter coefficients.

The filter coefficient selector 28 is also connected to the counter 26.

In accordance with the invention, the processor 22 informs the counter 26 and the filter coefficient selector 28 of the interpolation degree that is to be used for calculating the next output 16.

The processor 22 sets the value of the phase increment register 24 for producing the required output 16. The value of the phase increment register 24 will be M/L, where L and M are integers and is determined by the processor 22 on the basis of the instructions received from the controller 2.

The phase increment value is passed to an adder 30. The adder 30 is connected to a phase register 32 that records the current phase. The output of the adder 30 comprises an integer part and a fractional part.

Both the integer part and fractional part of the output of the phase register are fed back to the adder 30.

The integer part of the output of phase register 32 is also passed to a second adder 34 where it is added to the output of the counter 26. The integer output of the adder 34 is connected to the wave-table memory 6 and determines a sample that is to be read out.

The samples that are retrieved from the wave-table memory are passed to a multiply-accumulate circuit 36.

In addition to being fed into the adder 30, the fractional part of the phase register 32 output is fed to the filter coefficient selector 28.

The output of the filter coefficient selector 28 is passed to the multiply-accumulate circuit 36 where it is combined with the samples retrieved from the wave-table memory 6.

The operation of the voice 4 is now briefly described.

When the input of the phase register 32 is a non-integer value, i.e. the fractional part is non-zero, the required sample lies between two tabulated samples. Therefore the required sample must be calculated.

The adder 30 operates once per sample period to add the phase increment from the phase increment register 24 to the current phase (provided by the phase register 32).

The integer part of the phase register 32 output indicates the wave-table memory address that contains the stored sample immediately before the required sample. To calculate the required sample, a number of samples equal to I_{D} are read out from the wave-table memory 6.

The counter 26 increments by one each time to select I_{D} samples from around the required sample. Therefore, when I_{D} is 8, four samples before the required sample are read out along with four samples after the required sample. If I_{D} is 5, three samples before the required sample are read out along with two samples after the required sample. Alternatively, two samples before the required sample are read out and three samples after the required sample. These samples are passed to the multiply-accumulate circuit 36.

It should be noted that the counter operates from its initial value to its final value once each sample period.

The filter coefficient selector 28 obtains appropriate filter coefficients from the filter table 8 depending upon the fractional part of the phase register output and the interpolation degree. The filter coefficient selector 28 is controlled by the counter 26 to obtain I_{D} coefficients from the filter table 8.

Once the filter coefficients 44 have been obtained from the filter table 8, the input received from the counter 26 is used to pass the filter coefficients to the multiply-accumulate circuit 36. Here, the samples obtained from the wave-table memory 6 are multiplied with the appropriate filter coefficients 44, and the products added to obtain the output for the voice 16.

As the fractional part of the phase register 32 changes, the filter coefficients obtained from the filter table 8 will change.

As the number of active voices 4 changes, the processor will instruct the counter 26 and filter coefficient selector 28 of the required interpolation degree as appropriate.

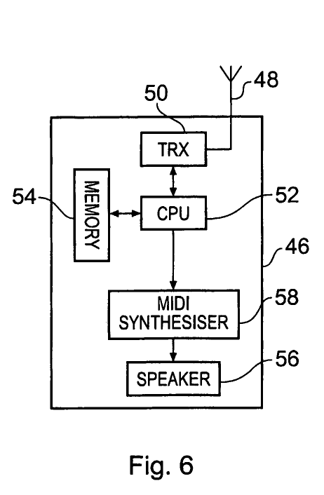

FIG. 6 shows a mobile phone with a music synthesiser in accordance with the invention. Although the invention is described as being incorporated in a mobile phone, it will be appreciated that the invention is applicable to any portable device such as a personal digital assistant (PDA), pagers, electronic organisers, or any other equipment in which it is desirable to be able to reproduce high quality polyphonic sound.

As is conventional, the mobile phone 46 comprises an antenna 48, transceiver circuitry 50, a CPU 52, a memory 54 and a speaker 56.

The mobile phone 46 also comprises a MIDI synthesiser 58 in accordance with the invention. The CPU 52 provides the MIDI synthesiser 58 with MIDI files. The MIDI files may be stored in a memory 54, or may be downloaded from a network via the antenna 48 and transceiver circuitry 50.

There is thus described a sound synthesiser that reduces the computational requirements of a synthesiser with a high degree of polyphony, while ensuring that audible artefacts are kept to a minimum.

1. A synthesizer comprising:
a memory, containing a plurality of stored samples;
means for calculating an output sample for each of a plurality of active voices using a plurality of samples selected from the stored samples for each of the active voices, the number of samples selected being defined as an interpolation degree;
wherein the interpolation degree depends upon the number of active voices.

2. A synthesizer as claimed in claim 1, wherein the interpolation degree decreases as the number of active voices increases.

3. A synthesizer as claimed in claim 1, wherein the interpolation degree decreases non-linearly as the number of active voices increases.

4. A synthesizer as claimed in claim 1 wherein the plurality of samples stored in the memory comprise samples of musical notes.

5. A synthesizer as claimed in claim 4 wherein the plurality of samples stored in the memory comprise samples of musical notes produced by different musical instruments.

6. A synthesizer as claimed in claim 1 wherein the means for calculating an output sample is adapted to multiply each selected sample with a respective filter coefficient obtained from a filter table.

7. A synthesizer as claimed in claim 6 wherein the filter table contains coefficients of a truncated sinc function.

8. A synthesizer as claimed in claim 1, wherein the synthesizer is a MIDI 30 music synthesizer.

9. A portable device, comprising a synthesizer, said synthesizer including a memory, containing a plurality of stored samples;
means for calculating an output sample for each of a plurality of active voices using a plurality of samples selected from the stored samples for each of the active voices, the number of samples selected being defined as an interpolation degree;
wherein the interpolation degree depends upon the number of active voices.

10. A portable device as claimed in claim 9 wherein the portable device is a mobile 35 phone.

11. A portable device as claimed in claim 9 wherein the portable device is a pager.

12. A method of operating a synthesizer having a plurality of samples stored in a memory, the method comprising the steps of:
determining the number of voices that will be active in producing a sound;
determining an interpolation degree on the basis of the number of voices that will be active, wherein the interpolation degree is defined as the number of samples to be selected from the plurality of samples stored in the memory; and
calculating an output sample for each active voice, using the number of said stored samples determined by the interpolation degree.

13. A method as claimed in claim 12, wherein the interpolation degree decreases as the number of active voices increases.

14. A method as claimed in claim 12, wherein the interpolation degree decreases non-linearly as the number of active voices increases.

15. (canceled)

16. (canceled)
